(19) United States
(12) Patent Application Publication
(10) Pub. No.: US 2017/0217271 A1
(43) Pub. Date: Aug. 3, 2017

(54) SNOWMOBILE FLOTATION SYSTEMS

(71) Applicant: Craig Allen Portsmouth, Hines Creek (CA)

(72) Inventor: Craig Allen Portsmouth, Hines Creek (CA)

(21) Appl. No.: 15/011,095

(22) Filed: Jan. 29, 2016

(51) Int. Cl. B60F 3/00; B63B 1/04

(52) U.S. Cl. CPC B60F 3/0076; B63B 1/04

(57) ABSTRACT

A snowmobile accessory that includes two buoyant front skis and two buoyant rear floats to mount under foot boards or running boards. A user with a snowmobile may simply mount the kit to a snowmobile for use when crossing bodies of water dry land, snow & ice. The present invention may be mounted in less than 30 minutes.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of snowmobile accessories and more specifically relates to a snowmobile flotation system for use in crossing bodies of water.

2. Description of Related Art

The challenges of cross-country transportation in the winter led to the invention of the snowmobile, an all-terrain vehicle specifically designed for travel across deep snow where other vehicles floundered. During the 20th century, rapidly evolving designs produced machines that were two-person tracked vehicles powered by gas engines that enabled them to tow a sled or travel, initially at low-to-moderate speeds, depending on snow conditions, terrain and obstacles protruding above the snow like brush and trees. Where early designs had 7.5 kW (10 horsepower) two-stroke engines, there has been a move toward newer style 2-stroke and 4-stroke gasoline engines, some with over 150 kW (200 hp).

A personal water craft (PWC), also called water scooter, is a recreational watercraft that the rider sits or stands on, rather than inside of, as in a boat. PWCs have two style categories. The first and most popular being a “sit down”, where the rider uses the watercraft mainly sitting down and typically holds two or more people. The second style is a “stand up”, where the rider uses the watercraft standing up. The stand up styles are built for one rider and is used more for doing tricks, racing, and are used in competitions. Both styles have an inboard engine driving a pump jet that has a screw-shaped impeller to create thrust for propulsion and steering. They are often referred by the trademarked brand names Jet Ski®, WaveRunner®, or Sea-Doo®. Most are designed for two or three people, though four-passenger models exist. The United States Coast Guard defines a personal watercraft, amongst other criteria, as a jet drive boat less than 4 m (13 feet) in length, in order to exclude from that definition more conventional sized jet boats.

Snowmobiles are only seasonal in some locations. Personal water craft are also limited in their functionality. A means for promoting multifunctional use is desirable for such machines.

Several attempts have been made to solve the above-mentioned problems such as those found in U.S. Pub. And Pat. Nos. 2008/0271303 to Allen Roberts; and 2006/0061052 to Rene Lemieux, U.S. Pat. No. 3,853,085 to Halboth R; U.S. Pat. No. 5,682,832 to Wayne C. Millard; U.S. Pat. No. 8,286,988 to Lynn Robert Jones; U.S. Pat. No. 3,841,649 to Mcmullen W; U.S. Pat. No. 5,682,832 to Wayne C. Millard; U.S. Pat. No. 8,777,680 to Kenneth James Macdonald; U.S. Pat. No. 6,431,561 to Jan M. Hedlund; U.S. Pat. No. 6,692,009 to Rene Lemieux; U.S. Pat. No. 8,641,055 to Verlin M. Simmons; U.S. Pat. No. 6,331,008 to Dale DeWayne Cormican; U.S. Pat. No. 6,199,648 to Ronald C. Kanan; and U.S. Pat. No. 4,491,333 to Wayne L. Warnke. This art is representative of snowmobile accessories. However, none of the above inventions and patents, taken either singly or in combination, is seen to describe the invention as claimed.

Preferably, a snowmobile accessory should provide a means for using a snowmobile year round on a variety of terrains and surfaces and, yet would operate reliably and be manufactured at a modest expense. Thus, a need exists for a reliable snowmobile flotation system to avoid the above-mentioned problems.

### BRIEF SUMMARY OF THE INVENTION

In view of the foregoing disadvantages inherent in the known snowmobile accessory art, the present invention provides a novel snowmobile flotation system. The general purpose of the present invention, which will be described subsequently in greater detail is to provide a snowmobile flotation system, when mounted, provides capability for the snowmobile to travel across bodies of water in a floating condition. A user does not need to remove the snowmobile flotation system due to terrain issues. The snowmobile flotation system may also be left on and the snowmobile and be driven on snow and ice.

A snowmobile flotation system is disclosed herein, in a preferred embodiment, comprising: a pair of front and a pair of rear floats functioning as snowmobile flotation assemblies each of the front and rear floats having a right-snowmobile-assembly and a left-snowmobile-assembly, each of the right-snowmobile-assembly and the left-snowmobile-assembly comprising a stern, a bow, a chine, a gunwhale, at least one cross-wise-thwart, and at least one length-wise-thwart. As such, the snowmobile flotation system comprises the snowmobile flotation assemblies comprising the right-snowmobile-assembly and the left-snowmobile-assembly (front and rear). The pair of snowmobile flotation assemblies each comprise fiberglass or injection molded plastic in preferred embodiments and may comprise other suitably equivalent materials in alternate embodiments. The snowmobile flotation assemblies must comprise durable material for longevity, rigidity, cost effectiveness, mass production and weigh.

The stern, the bow, the chine, the gunwhale, the at least one cross-wise-thwart and the at least one length-wise-thwart define each of the right-snowmobile-assembly and the left-snowmobile-assembly in functional and structural combination. The density of the right-snowmobile-assembly and the left-snowmobile-assembly is preferably less than 1 g/cm3; the density of 1 g/cm3 provides that the right-snowmobile-assembly and the left-snowmobile-assembly are able to effectively float. Other versions that are one-piece construction (not independent) are also envisioned.

Each of the right-snowmobile-assembly and the left-snowmobile-assembly in preferred embodiments comprises exactly three of the cross-wise-thwarts placed in substantially parallel configuration. The cross-wise-thwart comprising a front position comprises a substantially triangular shape with an apex. The second and third cross-wise-thwart comprise a low profile pentagon shape. The apex is located adjacent to the chine and the gunwhale meeting at a juncture between the two. Each of the right-snowmobile-assembly and the left-snowmobile-assembly comprises exactly two of the length-wise-thwarts in preferred embodiments (alternate embodiments may comprise more or less). Two of the cross-wise-thwarts are located perpendicularly to two of the length-wise-thwarts.

The stern, the bow, the chine, the gunwhale, the at least one cross-wise-thwart and the at least one length-wise-thwart are structured and arranged in functional combination for removable attachment to a respective ski mount of a snowmobile via suitable fastening means. The stern is oriented underneath respective running boards on the snowmobile, when used (installed), such that the bow is able to cut through water when traversing over bodies of water. The two rear floats are mounted along side of the running boards. The stern comprises a low profile pentagon shape.

The right-snowmobile-assembly and the left-snowmobile-assembly comprise a low-profile such that the snowmobile is suitably stabilized during use on the bodies of water. Rear floats help maintain stability in conjunction with the front floats. A center of gravity of the snowmobile is designed to be located (directed) directly below handlebars. The at least one cross-wise-thwart and the at least one length-wise-thwart is structured and arranged in respective boxed formations to provide respective defined inner volumes wherein the respective ski mounts of the snowmobile are able to be removably attached therein. The boxed condition provides for rigidity in use. The snowmobile flotation system, when mounted, provides capability for the snowmobile to travel across the bodies of water in a floating condition.

A kit is described herein including: the front and rear right-snowmobile-assembly, the front and rear left-snowmobile-assembly, and a set of user instructions for mounting to the snowmobile. The kit may further comprise any necessary mounting hardware.

A method of using a snowmobile flotation system is also disclosed herein comprising the steps of: mounting a right-snowmobile-assembly to a right ski mount, mounting a left-snowmobile-assembly to a left ski mount, a right rear snowmobile assembly to a right rear running board, and a left rear snowmobile assembly to a left rear running board and driving a snowmobile on bodies of water in a floating condition. The method may further comprise the step of removing the right-snowmobile-assembly and the left-snowmobile-assembly from the snowmobile.

The present invention holds significant improvements and serves as a snowmobile flotation system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, snowmobile flotation systems, constructed and operative according to the teachings of the present invention.

FIG. 1 shows a perspective view illustrating a snowmobile flotation system during an ‘in-use’ condition showing a front and rear right-snowmobile-assembly and left-snowmobile-assembly according to an embodiment of the present invention.

FIG. 2 is a perspective view illustrating the snowmobile flotation system comprising the right-snowmobile-assembly and left-snowmobile-assembly according to an embodiment of the present invention of FIG. 1.

FIG. 3 is a perspective view illustrating components of the snowmobile flotation system according to an embodiment of the present invention of FIGS. 1-2.

FIG. 4 is a perspective view illustrating the snowmobile flotation system according to an embodiment of the present invention of FIGS. 1-3.

FIG. 5 is a method of use for the snowmobile flotation system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a snowmobile accessory and more particularly to a bolt on (removably couplable) floatation kit for use with a snowmobile; two buoyant front skis and two buoyant rear floats to mount under (or otherwise adjacent) foot boards/running boards for total of four floats.

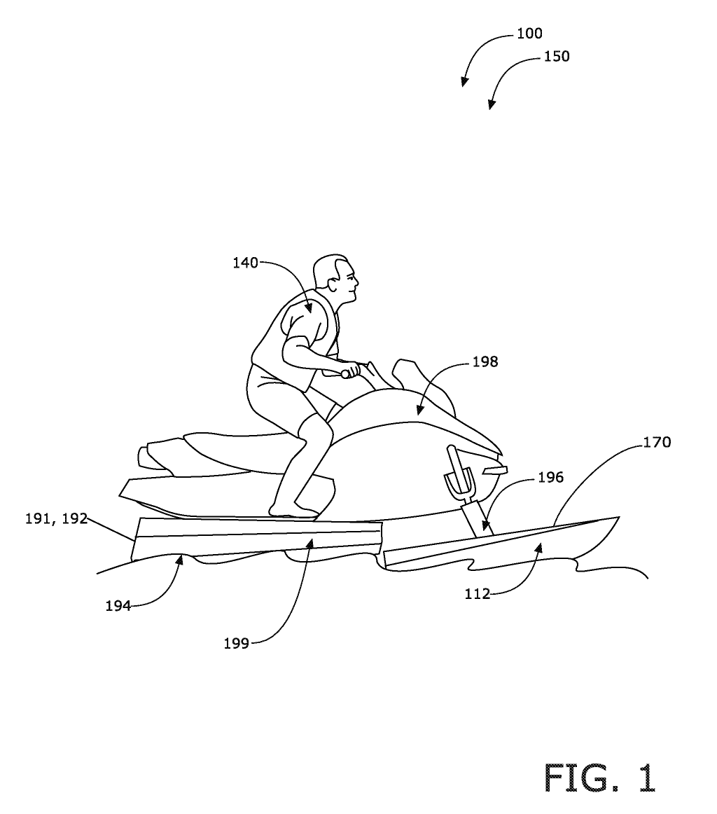

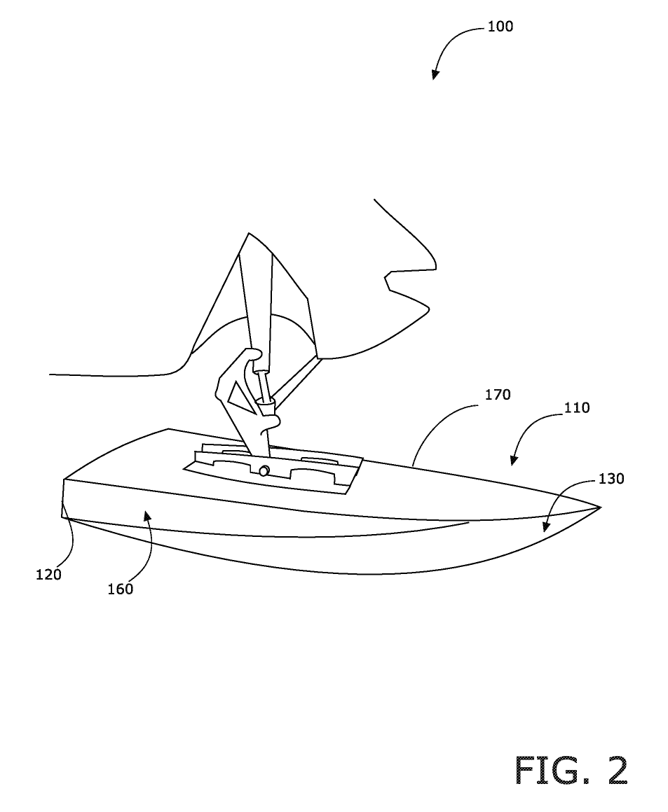

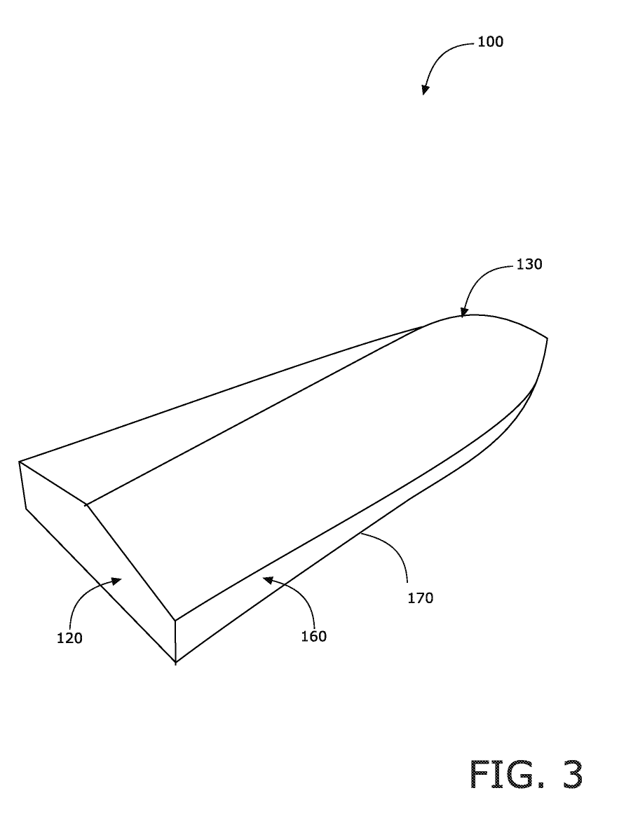

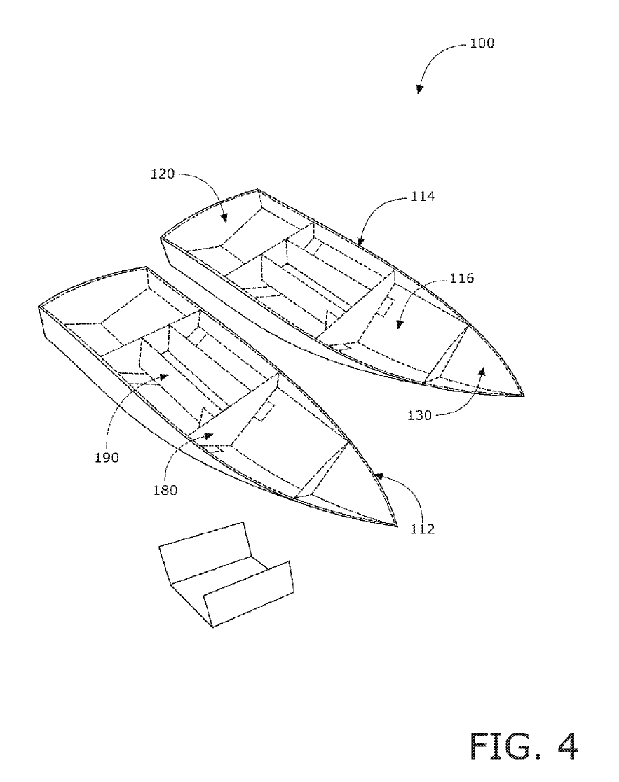

Referring to the drawings by numerals of reference there is shown in FIGS. 1-4, showing various views of snowmobile flotation system 100 comprising: pair of snowmobile flotation assemblies 110 comprising right-snowmobile-assembly 112 and left-snowmobile-assembly 114, each of right-snowmobile-assembly 112 and left-snowmobile-assembly 114 comprising, stern 120, bow 130, chine 160, gunwhale 170, at least one cross-wise-thwart 180, and at least one length-wise-thwart 190, as shown.

Snowmobile flotation system 100 comprises snowmobile flotation assemblies 110 comprising front and rear right-snowmobile-assembly 112 and front and rear left-snowmobile-assembly 114, stern 120, bow 130, chine 160, gunwhale 170, at least one cross-wise-thwart 180 and at least one length-wise-thwart 190 which define each of right-snowmobile-assembly 112 and left-snowmobile-assembly 114 in functional and structural combination. Stern 120, bow 130, chine 160, gunwhale 170, at least one cross-wise-thwart 180 and at least one length-wise-thwart 190 are structured and arranged in functional combination for removable attachment each to a respective (right and left) ski mount 196 of snowmobile 198.

At least one cross-wise-thwart 180 and at least one length-wise-thwart 190 is structured and arranged in respective boxed formations to provide respective defined inner volumes (right and left) wherein respective ski mounts 196 of snowmobile 198 are able to be removably attached therein. Snowmobile flotation system 100, when mounted, provides capability for snowmobile 198 to travel across bodies of water 194 in a floating condition. Pair of snowmobile flotation assemblies 110 may comprise wood in preferred embodiments or plastic in alternate embodiments. Upon reading this specification, it should be appreciated that, under appropriate circumstances, considering such issues as user preferences, design preference, structural requirements, marketing preferences, cost, available materials, technological advances, etc., other material arrangements such as, for example, composites, ferrous materials, non-ferrous materials, etc., may be sufficient.

In preferred embodiments each of right-snowmobile-assembly 112 and left-snowmobile-assembly 114 comprises exactly three of cross-wise-thwarts 180. Each of right-snowmobile-assembly 112 and the left-snowmobile-assembly 114 comprises exactly two length-wise-thwarts 190. Two cross-wise-thwarts 180 are located perpendicularly to two length-wise-thwarts 190. Stern 120 is oriented behind bow 130, when used, such that bow 130 is able to cut through the water when traversing over the bodies of water 194. Relationally speaking, stern 120 is located underneath or beside respective running boards 199 on snowmobile 198 when mounted.

Cross-wise-thwart 180 when comprising a front position comprises a triangular shape with an apex. The apex is located adjacent an intersection of chine 160 and gunwhale 170. A second and third the cross-wise-thwart 180 comprise a low profile pentagon shape, as shown. Stern comprises a low profile pentagon shape. A density of the right-snowmobile-assembly 112 and left-snowmobile-assembly 114 is less than 1 g/cm³. The density of 1 g/cm³ provides that right-snowmobile-assembly 112 the left-snowmobile-assembly 114 is able to effectively float. Other materials with other densities may be used; however it is preferable that the material be buoyant in water.

Right-snowmobile-assembly 112 and the left-snowmobile-assembly 114 comprise a low-profile such that snowmobile 198 is suitably stabilized during use on bodies of water 194. A center of gravity of snowmobile 198 is designed to be located (directed) directly below handlebars.

Snowmobile flotation system 100 may be sold as kit 440 comprising the following parts: at least one front and rear right-snowmobile-assembly 112; at least one front and rear left-snowmobile-assembly 114; and at least one set of user instructions. The kit 440 may further comprise any necessary mounting hardware. The kit has instructions such that functional relationships are detailed in relation to the structure of the invention (such that the invention can be used, maintained, or the like in a preferred manner). Snowmobile flotation system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different mounting combinations, parts may be sold separately, etc., may be sufficient. The present kit can be universally mounted to any production snowmobile in production.

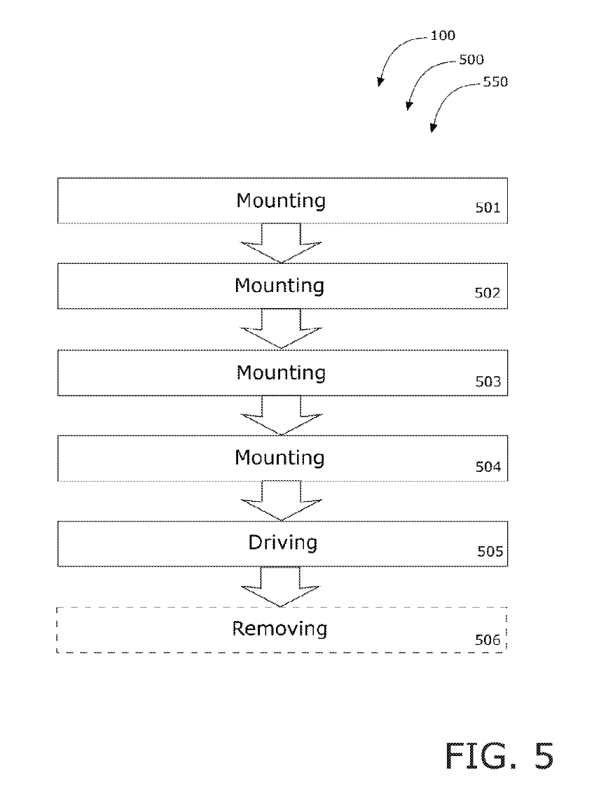

Referring now to FIG. 5 showing flowchart 550 illustrating method of use 500 for snowmobile flotation system 100 according to an embodiment of the present invention of FIGS. 1-4. As shown, method of use 500 may comprise the steps of: step one 501, mounting right-snowmobile-assembly 112 to a right ski mount, step two 502 mounting left-snowmobile-assembly 114 to a left ski mount, step three 503 driving snowmobile 198 on bodies of water in a floating condition, and step four 504 removing right-snowmobile-assembly 112 and left-snowmobile-assembly 114 from snowmobile 198. Rear mounted floatation means may comprise two buoyant rear floats to support a rear portion of snowmobile 198 mounted underneath running boards 199 or other portion of the rear of snowmobile 198.

It should be noted that step four 504 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A snowmobile flotation system comprising:
a pair of snowmobile flotation assemblies comprising a right-snowmobile-assembly and a left-snowmobile-assembly, each of said right-snowmobile-assembly and said left-snowmobile-assembly comprising;
a stern;
a bow;
a chine;
a gunwale;
at least one cross-wise-thwart; and
at least one length-wise-thwart,
wherein each of said right-snowmobile-assembly and said left-snowmobile-assemblies are removeably attached to a respective ski mount of a snowmobile;
wherein each of said at least one cross-wise-thwart and said at least one length-wise-thwart are configured to form at least a portion of a box structure defining a respective inner volume that accommodates said respective ski mount of said snowmobile that is removably attached therein.

2. The snowmobile flotation system of claim 1, wherein said pair of snowmobile flotation assemblies comprises wood.

3. The snowmobile flotation system of claim 1, wherein said pair of snowmobile flotation assemblies comprises plastic.

4. The snowmobile flotation system of claim 1, wherein each of said right-snowmobile-assembly and said left-snowmobile-assembly comprises exactly three of said cross-wise-thwarts.

5. The snowmobile flotation system of claim 1, wherein each of said right-snowmobile-assembly and said left-snowmobile-assembly comprises exactly two of said length-wise-thwarts.

6. The snowmobile flotation system of claim 1, wherein two of said cross-wise-thwarts are located perpendicularly to two of said length-wise-thwarts.

7. The snowmobile flotation system of claim 1, wherein said stern is oriented behind said bow when used, such that said bow traverses over a surface of a body of water and also transverses over dry land, snow, and ice.

8. The snowmobile flotation system of claim 7, wherein said stern is located underneath respective handlebars on said snowmobile.

9. The snowmobile flotation system of claim 5, wherein said cross-wise-thwart comprising a front position comprises a triangular shape with an apex.

10. The snowmobile flotation system of claim 9, wherein said apex is located adjacent an intersection of said chine and said gunwale.

11. The snowmobile flotation system of claim 1, wherein a second and a third said cross-wise-thwart each have a pentagon shape.

12. The snowmobile flotation system of claim 1, wherein said stern has a pentagon shape.

13. The snowmobile flotation system of claim 1, wherein a density of said right-snowmobile-assembly and said left-snowmobile-assembly is less than 1 g/cm³.

14. The snowmobile flotation system of claim 13, wherein said density of 1 g/cm³ provides that said right-snowmobile-assembly and said left-snowmobile-assembly is able to effectively float.

15-16. (canceled)

17. A snowmobile flotation system comprising:
a pair of snowmobile flotation assemblies comprising a right-snowmobile-assembly and a left-snowmobile-assembly, each of said right-snowmobile-assembly and said left-snowmobile-assembly comprising:
a stern;
a bow;
a gunwale;
at least one cross-wise-thwart;
at least one length-wise-thwart; and
two buoyant rear floats;
wherein said cross-wise-thwart comprising a front position comprises a triangular shape with an apex;
wherein said apex is located adjacent to said chine and said gunwale;
wherein each of said right-snowmobile-assembly and said left-snowmobile-assembly are removably attached to a respective ski mount of a snowmobile;
wherein said stern is located underneath respective running boards on said snowmobile;
wherein each of said at least one cross-wise-thwart and said at least one length-wise-thwart are configured to form a portion of a box structure defining a respective inner volume accommodating said respective ski mount of said snowmobile that is removably attached therein; and
wherein said two buoyant rear floats support a rear portion of said snowmobile from underneath footboards.

18. A kit including:
a right-snowmobile-assembly;
a left-snowmobile-assembly;
bouyant rear floats; and
a set of user instructions.

19-20. (canceled)
